(19) United States
(12) Patent Application Publication
(10) Pub. No.: US 2013/0086156 A1
(43) Pub. Date: Apr. 4, 2013

(54) COUPLED APPLICATION EXTENSIONS FOR COLLABORATIVE REMOTE APPLICATION SHARING

(71) Applicant: Calgary Scientific Inc., Calgary (CA)

(72) Inventors: David Bruce McFadzean, Canmore (CA); Glen Lehmann, Crossfield (CA)

(73) Assignee: CALGARY SCIENTIFIC INC., Calgary (CA)

(21) Appl. No.: 13/632,295

(22) Filed: Oct. 1, 2012

Related U.S. Application Data
(60) Provisional application No. 61/541,550, filed on Sep. 30, 2011.

(51) Int. Cl. H04L 29/06

(52) U.S. Cl. CPC H04L 67/42
USPC 709/203

(57) ABSTRACT

Systems and method for providing for decoupled application extensions to a remote access application. The application extensions are provided as part the remote access application to provide features and functionalities that otherwise are not provided by underlying the application programs that are made available by the remote access program. These features and functionalities may be provided without a need to modify the underlying application program, as they are integral with the remote access application.

### CROSS-REFERENCE TO RELATED APPLICATION

The present application claims priority to U.S. Provisional Patent Application No. 61/541,550, filed Sep. 30, 2011, entitled “Coupled Application Extensions for Collaborative Remote Application Sharing,” which is incorporated herein by reference in its entirety.

### BACKGROUND

Ubiquitous remote access to services, application programs and data has become commonplace as a result of the growth and availability of broadband and wireless network access. As such, users are accessing application programs and data using an ever-growing variety of client devices (e.g., mobile devices, table computing devices, laptop/notebook/desktop computers, etc.). Data may be communicated to the devices from a remote server over a variety of networks including, 3G and 3G mobile data networks, wireless networks such as WiFi and WiMax, wired networks, etc. Clients may connect to a server offering the services, applications programs and data across many disparate network bandwidths and latencies.

In such an environment, applications may also be shared among remote users in a collaborative session. However, when collaborating, users may be limited solely to the functionalities provided by the shared application, thus limiting the collaborative session.

### SUMMARY

Disclosed herein are systems and methods for providing coupled application extensions in a remote access framework. In accordance with some implementations, there is disclosed a method of providing a coupled application extension to a remotely-accessed application. The method may include providing a tiered remote access framework comprising an application tier, a server tier and a client tier, the tiered remote access framework communicating first information regarding the remotely-accessed application between client computing devices accessing the remotely-accessed application in a collaborative session, the collaborative session communicating a state model between the client computing devices that is used to display the remotely-accessed application at the client computing devices; providing the coupled application extension in the client tier, the coupled application extension providing a functionality at the client computing devices by accessing the first information associated with the remotely-accessed application; and modifying the state model to further include second information regarding the coupled application extension such that the functionality associated with the coupled application extension is enabled in at least one of the client computing devices.

In accordance with some implementations, there is disclosed a method of providing a coupled application extension to a remotely-accessed application. The method may include providing a tiered remote access framework comprising an application tier, a server tier and a client tier, the tiered remote access framework enabling client computing devices to connect to the remotely-access application in a collaborative fashion, the tiered remote access framework further communicating a state model that contains first information utilized by the client computing devices to synchronize a display associated with the remotely-accessed application; providing the coupled application extension in at least one of the server tier, the client tier and the application tier, the coupled application extension providing a functionality at the client computing devices by accessing the first information associated with the remotely-accessed application; and modifying the state model to further include second information regarding the coupled application extension such that the functionality associated with the coupled application extension is enabled in at least one of the client computing devices.

In accordance with some implementations, there is disclosed a tangible computer readable medium having computer readable instructions stored thereon that when executed by a processor of a computing device perform a method of providing a coupled application extension to a remotely-accessed application. The method executed thereby may include providing a tiered remote access framework comprising an application tier, a server tier and a client tier, the tiered remote access framework enabling client computing devices to connect to the remotely-access application in a collaborative fashion, the tiered remote access framework further communicating a state model that contains first information utilized by the client computing devices to synchronize a display associated with the remotely-accessed application; providing the coupled application extension in at least one of the server tier, the client tier and the application tier, the coupled application extension providing a functionality at the client computing devices by accessing the first information associated with the remotely-accessed application; and modifying the state model to further include second information regarding the coupled application extension such that the functionality associated with the coupled application extension is enabled in at least one of the client computing devices.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a simplified block diagram illustrating a system for providing remote access to an application at a remote device via a computer network;

FIG. 2 is a state model in accordance with the present disclosure;

FIGS. 3A and 3B illustrate additional aspects of the system of FIG. 1;

FIGS. 4A and 4B illustrate an example user interface containing an application that may be shared in a collaborative session between users of client computing devices;

FIG. 5 illustrates a flow diagram of example operations performed within the system of FIGS. 1-3; and

FIG. 6 illustrates an exemplary computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described for remotely accessing applications, it will become evident to those skilled in the art that the implementations are not limited thereto, but are applicable for remotely accessing any type of data or service via a remote device.

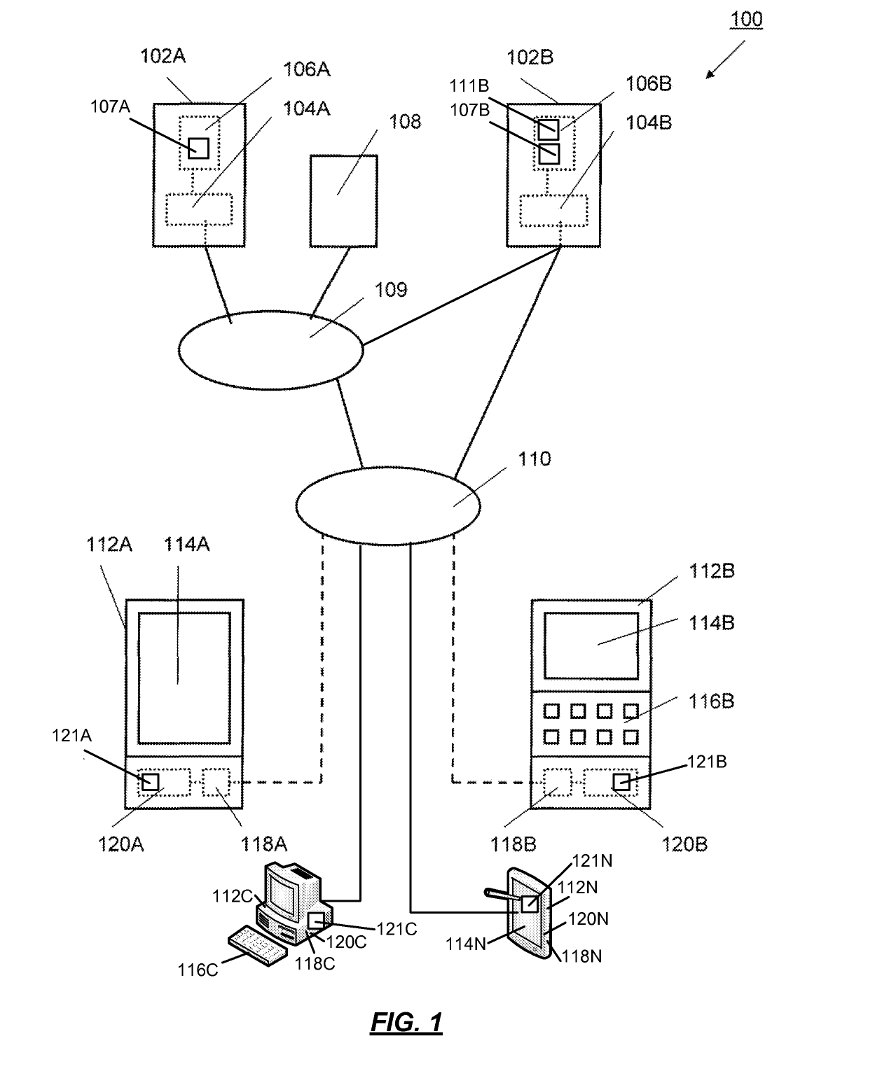

Referring to FIG. 1, a system 100 for providing remote access to an application, data or other service via a computer network. The system comprises a client computing device 112A or 112B, such as a wireless handheld device such as, for example, an IPHONE 112A or a BLACKBERRY 112B connected via a computer network 110 such as, for example, the Internet, to a server 102B. Similarly, the client computing devices may also include a desktop/notebook personal computer 112C or a tablet device 112N that are connected by the communication network 110 to the server 102B. It is noted that the connections to the communication network 110 may be any type of connection, for example, Wi-Fi (IEEE 802.11x), WiMax (IEEE 802.16), Ethernet, 3G, 4G, etc.

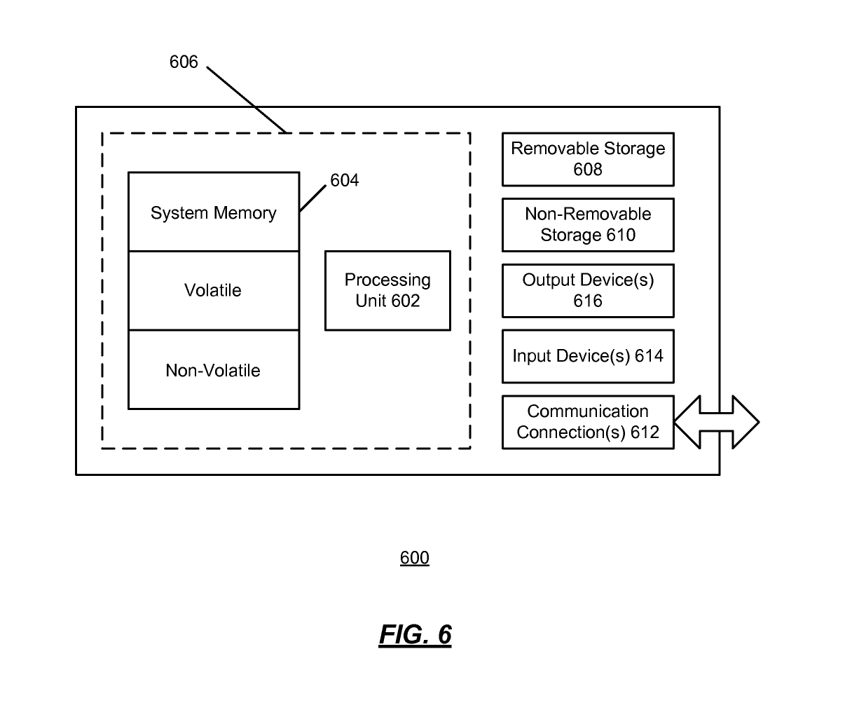

The server 102B is connected, for example, via the computer network 110 to a Local Area Network (LAN) 109 or may be directly connected to the computer network 110. For example, the LAN 109 is an internal computer network of an institution such as a hospital, a bank, a large business, or a government department. Typically, such institutions still use a mainframe computer 102A and a database 108 connected to the LAN 109. Numerous application programs 107A may be stored in memory 106A of the mainframe computer 102A and executed on a processor 104A. Similarly, numerous application programs 107B may be stored in memory 106B of the server 102B and executed on a processor 104B. The application programs 107A and 107B may be “services” offered for remote access. The mainframe computer 102A, the server 102B and the client computers 112A, 112B, 112C or 112N may be implemented using hardware such as that shown in the general purpose computing device of FIG. 6.

A client remote access application 121A, 121B, 121C, 121N may be designed for providing user interaction for displaying data and/or imagery in a human comprehensible fashion and for determining user input data in dependence upon received user instructions for interacting with the application program using, for example, a graphical display with touch-screen 114A or a graphical display 114B/114N and a keyboard 116B/116C of the client computers 112A, 112B, 112C, 112N, respectively. For example, the client remote access application is performed by executing executable commands on processor 118A, 118B, 118C, 118N with the commands being stored in memory 120A, 120B, 120C, 120N of the client computer 112A, 112B, 112C, 112N, respectively.

Alternatively or additionally, a user interface program is executed on the server 102B (as one of application programs 107B) which is then accessed via an URL by a generic client application such as, for example, a web browser executed on the client computer 112A, 112B. The user interface is implemented using, for example, Hyper Text Markup Language HTML 5. In some implementations, the server 102B may participate in a collaborative session with the client computing devices 112A, 112B, 112C . . . 112N. For example, the aforementioned one of the application programs 107B may enable the server 102B to collaboratively interact with the application program 107A or another application program 107B and the client remote access applications 121A, 121B, 121C, 121N. As such, the server 102B and each of the participating client computing devices 112A, 112B, 112C . . . 112N may present a synchronized view of the display of the application program.

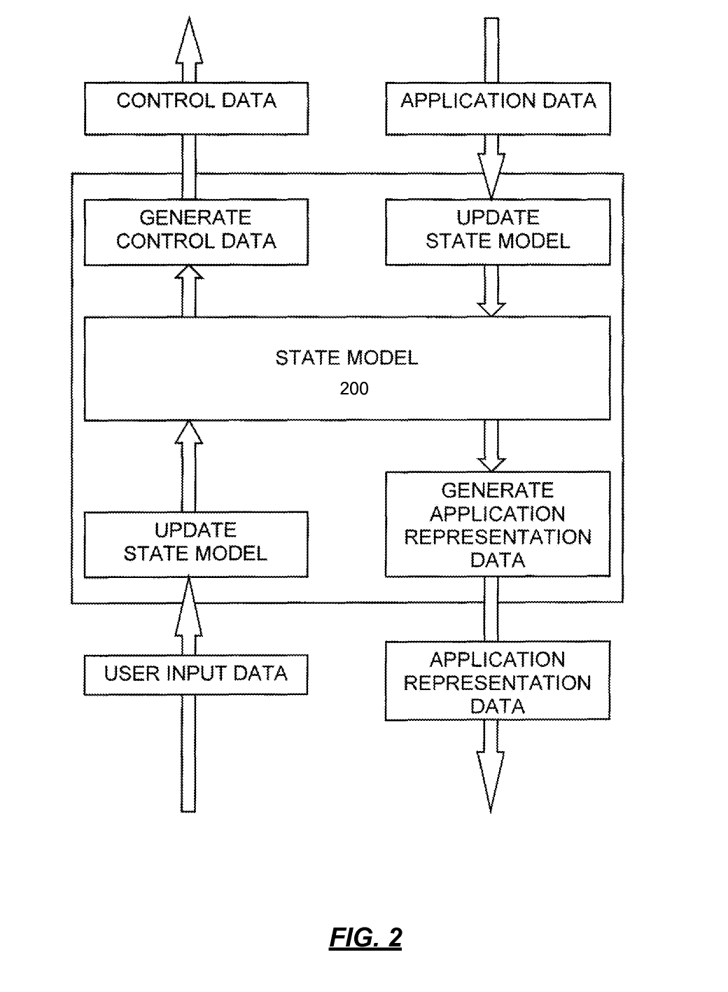

The operation of a server remote access application 111B with the client remote access application (any of 121A, 121B, 121C, 121N, or one of application programs 107B) is performed in cooperation with a state model 200, as illustrated in FIG. 2. An example of the server remote access program is PUREWEB, available from Calgary Scientific, Alberta, Canada. When executed, the client remote access application updates the state model 200 in accordance with user input data received from a user interface program. The remote access application may generate control data in accordance with the updated state model 200, and provide the same to the server remote access application 111B running on the server 102B.

Upon receipt of application data from an application program 107A or 107B, the server remote access application 111B updates the state model 200 in accordance with the screen or application data, generates presentation data in accordance with the updated state model 200, and provides the same to the client remote access application 121A, 121B, 121C, 121N on the client computing device. The state model 200 comprises an association of logical elements of the application program with corresponding states of the application program, with the logical elements being in a hierarchical order. For example, the logical elements may be a screen, a menu, a submenu, a button, etc. that make up the application program user interface. This enables the client device, for example, to natively display the logical elements. As such, a menu of the application program that is presented on a mobile phone will look like a native menu of the mobile phone. Similarly, the menu of the application program that is presented on desktop computer will look like a native menu of the desktop computer operating system.

The state model 200 is determined such that each of the logical elements is associated with a corresponding state of the application program 107A or 107B. The state model 200 may be determined such that the logical elements are associated with user interactions. For example, the logical elements of the application program are determined such that the logical elements comprise transition elements with each transition element relating a change of the state model 200 to one of control data and application representation data associated therewith.

In some implementations, two or more of the client computing devices 112A, 112B, 112C . . . 112N and/or the server 102B may collaboratively interact with the application program 107A or 107B. As such, by communicating state information between each of the client computing devices 112A, 112B, 112C . . . 112N and/or the server 102B and/or the mainframe computer 102A participating in a collaborative session, each of the participating client computing devices 112A, 112B, 112C . . . 112N may present a synchronized view of the display of the application program 107A or 107B.

In accordance with some implementations, the system 100 may provide for coupled application extensions. Such extensions are provided as part of either the server remote access application 111B, the client remote access applications 121A, 121B, 121C, 121N, or both to provide features and functionalities that are otherwise are not provided by the application programs 107A or 107B, but dependent on the application programs 107A or 107B. These features and functionalities may be provided without a need to modify the application programs 107A or 107B, as they are integral with the remote access applications.

The coupled application extensions also utilize information about the application state from the state model to provide the features and functionalities. As such, the functionality of the coupled application extensions depends on the application being displayed within the server remote access application 111B and client remote access application 121A, 121B, 121C, 121N. The application extensions may be made available within controls presented by the server remote access application 111B or client remote access application 121A, 121B, 121C, 121N, and may be always available.

For example, a measuring tool may be provided as an application extension to enable participants in a collaborative session to take measurements on top of the application running in the session. Details of the coupled application extensions and the measuring tool are provided below.

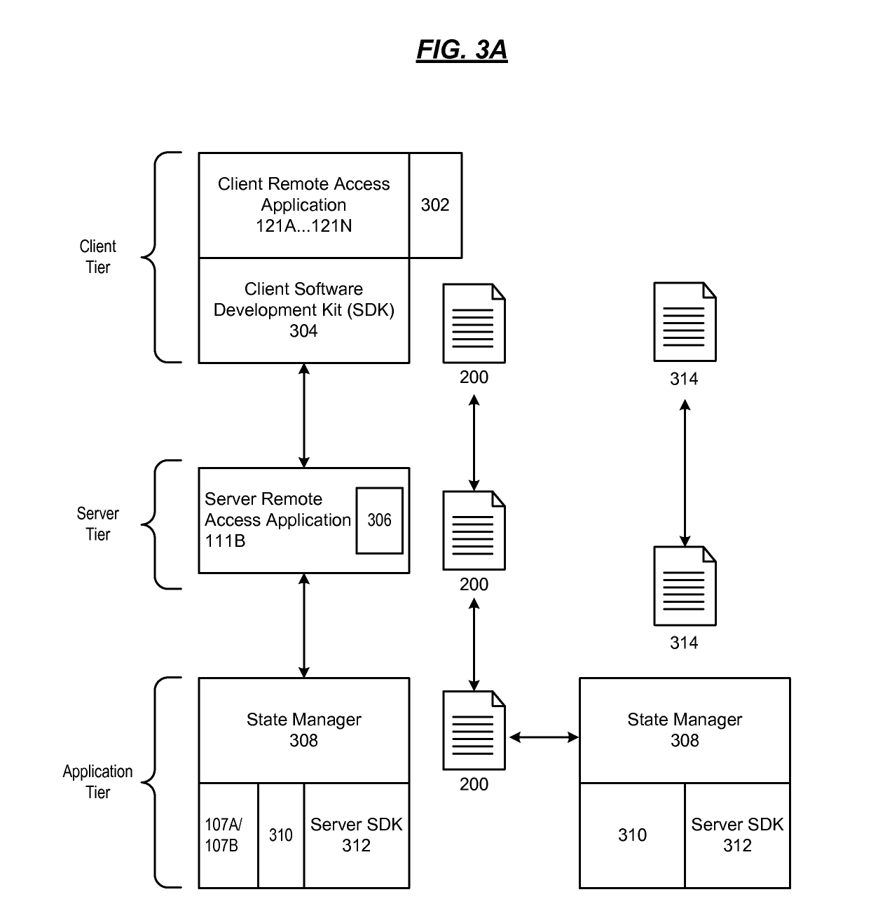

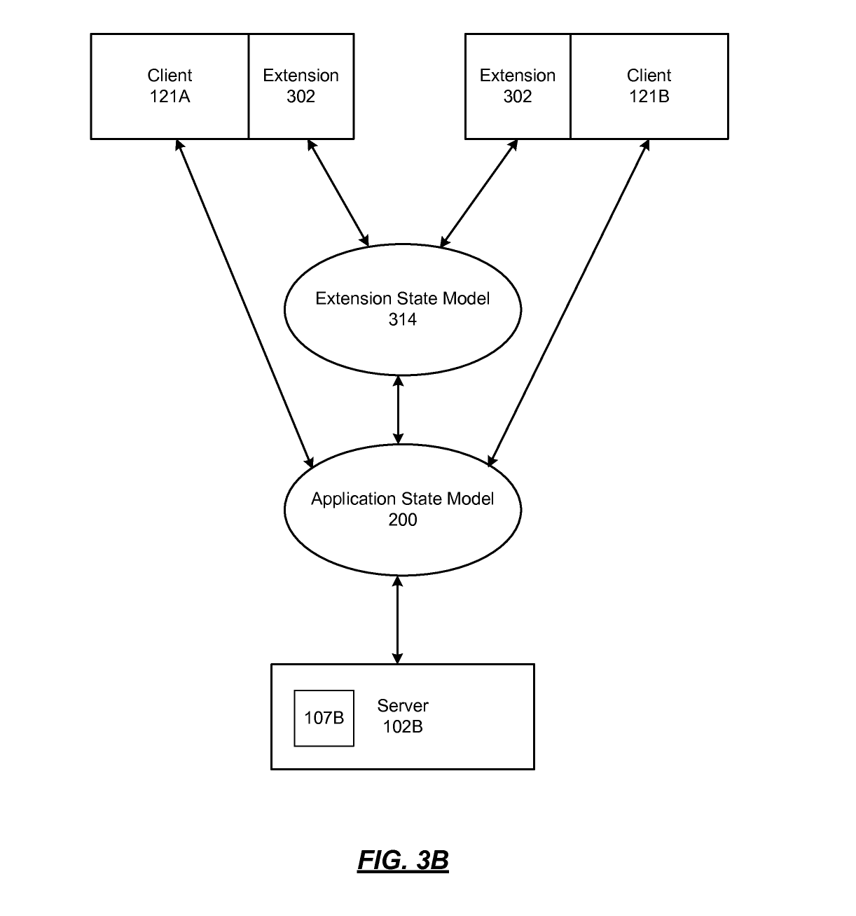

FIGS. 3A-3B illustrate aspects of the system 100 of FIG. 1 in greater detail. FIG. 3A illustrates the system 100 as having a tiered software stack. The client remote application 121A, 121B, 121C, 121N may sit on top of a client software development kit (SDK) 304 in a client tier. The client tier communicates to the server remote access application 111B in a server tier. The server tier communicates to a state manager 308 sitting on top of the applications 107A/107B and a server SDK 312 in an application tier. As noted above, the application extensions may be implemented in any of the tiers, i.e., within the server tier as an extension or plug-in 306, the client tier as client application extension 302, the application tier as application extension 310, or combinations thereof. The state model 200 is communicated among the tiers and may be modified in any of the tiers by the application extensions 302 and 310, and the plug-in 306.

As an example of a client application extension 302, a measuring tool may be provided to enhance the features of a map application. The measuring tool knows the resolution of a map being presented by the client remote access application on the client computing device. Using screen coordinates selected by, e.g., a user, the measuring tool may convert pixel locations to spatial coordinates to provide the user with an actual distance between selected points on the map.

Below is an example section of a state model used to implement the measuring tool as a client application extension 302. The state model may be represented in, e.g., an Extensible Markup Language (XML) document. Other representations of the state model are possible. Information regarding the application program and the measuring tool are communicated in the state model.

<ApplicationState >

<Screens>

<Screen id=“0” name=“Map” PixelResolutionWidth=“1024”
PixelResolutionHeight=“768”ContourInterval=“10” Unit=“kM”>
</Screen>

</Screens>
< Screen Data>

<CurrentScreen id=“0” />
<Screen id=“0”>
</Screen>

</ScreenData>

</ApplicationState>
<Collaboration>

<Sessions>

<UserInfo=“Glen” />
<UserInfo=“Jacquie” />

</Sessions>
<Views>

<Map>

<Sessions>

<UserName=“Glen” CP=“XY” MeasureTool=P1,P2 />
<UserName=“Jacquie” CP=“XY”/>

</Sessions>

</Map>

</Views>

</Collaboration>

Information regarding the application (107A or 107B) is maintained in the ApplicationState node in a first portion of the XML state model. Different states of the application program associated with the map view are defined, such as pixel resolutions (width and height). Also, information about the topographical map, such as a contour interval and a unit of measurement is maintained as part of the application state. The coupled collaboration states and application extension states are maintained in a second portion of the XML document to describe cursor positions, as well as a beginning point (P1) and an ending point (P2) of the measuring tool within the display. From the application state and the P1 and P2 values, the measuring tool may then determine a map distance between P1 and P2.

Thus, the state model may thus contain session information about the application itself, the application extension information, information about views, and how to tie the functionality of the application to the specific views. As such, any number of application extensions can be written that consume information in the state model to extend the functionality of the underlying application.

Alternatively or additionally, in the application tier, the application extension 310 may be a separate executable program that includes new business logic to enhance the applications 107A/107B. The application extension 310 may consume the state model 200 and produce its own document 314 (i.e., an extension state model of the application extension 310) that may include: (1) information from the state model 200 and information associated with the application extension 310, (2) only information associated with the application extension 310, or (3) a combination of some of the state model information and information associated with the application extension 310. The extension state model 314 may be communicated to the server remote access application 111B, where the server remote access application 111B may compose an updated state model 200 to include the information in the extension state model 314. Alternatively or additionally, the client remote access application 121A, 121B, 121C, 121N may receive both the state model 200 and the extension state model 314, and the client remote access application may compose an updated state model 200 to include the information in the extension state model 314.

As an example of the above, the application 107B may be a statistical analysis package and the application extension 310 may be a visualization application. The statistics generated by the statistical analysis package may be contained in the state model 200. The application extension 310, running as a separate application, consumes the statistics information in the state model 200 and creates, e.g., a graphical visualization of the statistics information. The application extension 310 may then place information related to the graphical visualization into the extension state model 314. The application extension 310 may forward the extension state model 314 to the client remote access application, send the extension state model 314 to server tier where the server remote access application 111B composes an updated state model 200 with the information in the state model 314, or may consume the state model 200 and include it in the extension state model 314, which is then communicated to the client remote access application.

In another example, the server plug-in 306 may be an application extension that enhances the capabilities of a mortgage calculator (as one of applications 107B). The mortgage calculator may provide calculations for U.S. mortgages. However, Canadian mortgages are calculated differently. As such, the plug-in 306 may be provided to intercept the state model 200 associated with the mortgage calculator and covert the data therein to provide a Canadian mortgage calculation. This is done without the need to rewrite the U.S. mortgage calculator. In another example, business logic may be added at the server tier as a plug-in 306 to provide additional capabilities to an application 107B running on the server 102B.

FIG. 3B illustrates the data flow of the extension state model 314 and the application state model 200 within the environment of FIGS. 1 and 2. The extension state model 314 contains information about the application extension 310 that is utilized by the client computing devices to provide, e.g., display information. As illustrated, the application extensions 302 communicate the extension state model 314 between the client computing devices, e.g., client computing device 121A and client computing device 121B. For example, the extension state model 314 may be communicated as part of the application state model 200 (i.e., coupled thereto) as the application state model 200 is communicated between the client computing device 121A, the client computing device 121B and, e.g., the server 102. As such, in accordance with the data flow of FIG. 3B, the states of the extension 310 and the application 107B may be synchronized between the various participants in a collaborative session.

Thus, generally, the present disclosure provides for application extensions that may be made available through a remote access mechanism. The application extensions provide application-dependent enhancements to applications through the remote access mechanism without the need to modify the applications themselves.

In an example implementation, the present disclosure provides for a measuring tool that may be used collaboratively to measure distances within an application that is being collaboratively shared among users. The measuring tool may be made available as a control within the environment of FIG. 1 when sharing a mapping tool application among users in a collaborative session. The measuring tool may be coupled to the application logic such that it is aware of the size of view and the resolution (size of the pixels in the view) in order to take a measurement on the view presented by the mapping tool. The measurement may be used by another part of the mapping tool. Thus, the application extensions may be coupled to the data model itself.

In some implementations, the measuring tool may be a client-specific application extension that is executed within the client remote access application 121A, 121B, 121C, 121N. For example, if the client computing device is an IPAD, the measuring tool application extension may be provided because a native measuring tool of the mapping tool application may be difficult to use in a touch-centric environment. Accordingly, a client-side, touch-centric application extension may be developed that may use information about a currently displayed view in the state model of FIG. 2 (e.g., resolution information) to convert on-screen measurements to, e.g., kilometers. The application extension using the state model information may, thus extend the functionality of the original application without modifying the source code.

In some implementations, the measuring tool application extension may be a server side plug-in executed by the server remote access application 111B. Using the state model, the server remote access application 111B may build the measuring tool on-top of the mapping tool to extend the functionality of the mapping tool without having to modify the original source code.

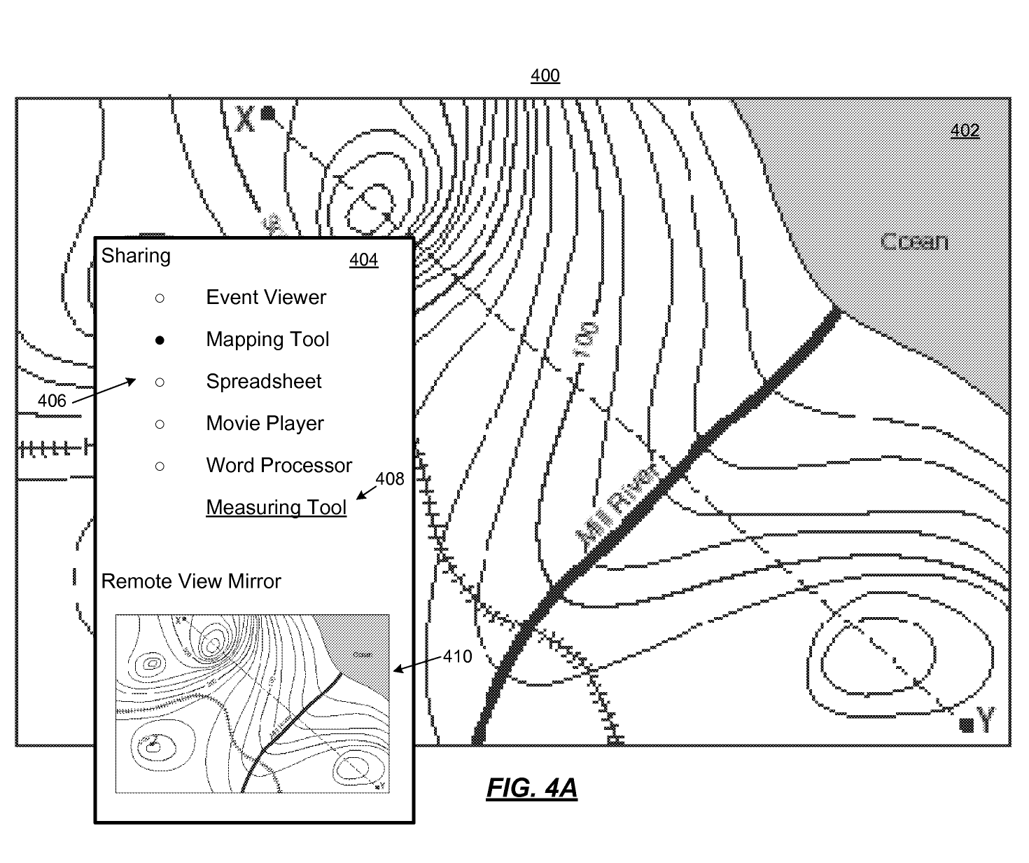

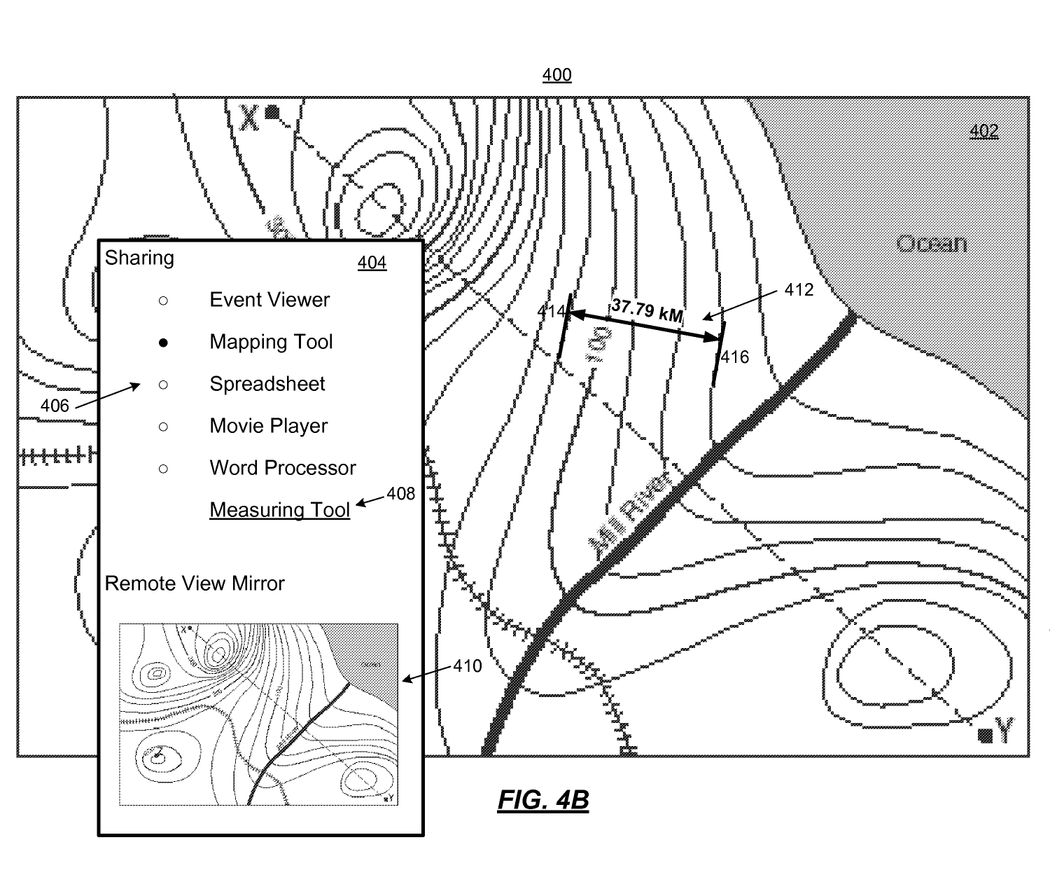

FIGS. 4A and 4B illustrate an example user interface 400 containing a mapping tool application 402 that may be shared in a collaborative session. As shown in FIG. 4A, a user at a first client computing device may activate a sharing control 404 using the client remote access application. The sharing control 404 may provide a list of all available applications which may be shared between users. In the example, five applications may be shared (e.g., an event viewer, the mapping tool, a spreadsheet, a movie player, and a word processor). In accordance with an aspect of the present disclosure, the sharing control 404 includes the measuring tool 408, which activates the measuring tool, as described above. The sharing control 404 may optionally include a remote view mirror 410, which displays the user interface as shown on a remote client computing device of another user to the collaborative session.

If the user activates the measuring tool 408, then the user interface 400 is operable to receive user input to measure distances on the topographical map. Referring to FIG. 4B, the user interface 400 is shown containing a measurement 412. For example, Glen may have placed points 414 (P1) and 416 (P2) to take a measurement between two contours. The client remote access application may create an arrow showing the calculated map distance (37.79 kM) based on information regarding the application state in the state model (see, above). Although not shown, the measuring tool 408 may be used collaboratively, as Jacquie may measure another distance on the topographical map shown in the mapping tool application 402.

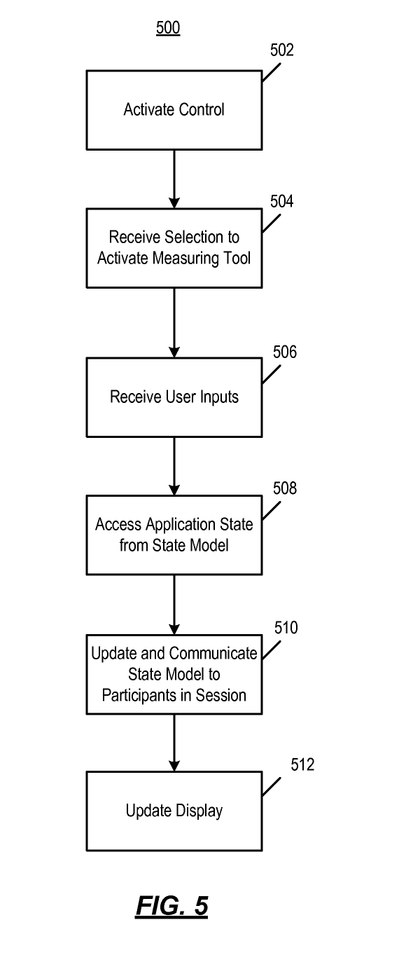

FIG. 5 illustrates a flow diagram 500 of example operations performed within the system of FIGS. 1-3. As described above, the server remote access application 111B of the server 102B provides access to one or more applications 107A or 107B, which is displayed by the client remote access application 121A, 121B, 121C, 121N. At 502, a user to a collaborative session activates a control provided by the client remote access application. The control may be, e.g., the sharing control 404.

At 504, a selection is received to activate the measuring tool. For example, a user may select the measuring tool 408 in the sharing control 404. At 506, user inputs are received in the mapping tool application. The user inputs may be received as points P1 and P2 by one or more of the users to the collaborative session to designate the starting point and ending point of a map distance to be measured. At 508, the measuring tool accesses the state model to obtain application state information, as noted above, to determine the application-dependent map distance between the specified points.

At 510, the state model is updated and communicated to participants in the collaborative session. For example, the state model may be updated to represent the points input by the user (or users) in the collaborative session. As described in FIG. 2, the state model may be passed among the client computing devices and the server, such that each client computing device and the server are synchronized. At 512, the participant displays are updated to reflect the contents of the state model. The display of each client computing device and the server may be updated to reflect current state of the state model, as shown in FIG. 4B.

FIG. 6 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communications connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of providing a coupled application extension to a remotely-accessed application, comprising:
providing a tiered remote access framework comprising an application tier, a server tier and a client tier, the tiered remote access framework communicating first information regarding the remotely-accessed application between client computing devices accessing the remotely-accessed application in a collaborative session, the collaborative session communicating a state model between the client computing devices that is used to display the remotely-accessed application at the client computing devices;
providing the coupled application extension in the client tier, the coupled application extension providing a functionality at the client computing devices by accessing the first information associated with the remotely-accessed application; and
modifying the state model to further include second information regarding the coupled application extension such that the functionality associated with the coupled application extension is enabled in at least one of the client computing devices.

2. The method of claim 1, further comprising providing the functionality by the coupled application extension by accessing the second information in the state model.

3. The method of claim 1, further comprising providing the state model as a markup language document having a plurality of tags, wherein a first plurality of the tags are associated with the remotely-accessed application, and a second plurality of the tags are associated with the coupled application extension.

4. The method of claim 3, wherein the coupled application extension provides the functionality based on information identified within the second plurality of the tags.

5. The method of claim 1, further comprising:
providing the functionality of the coupled application extension in accordance with a display state of the remotely-accessed application at the client computing devices.

6. The method of claim 1, wherein the coupled application extension is a mapping tool, wherein the second information comprises coordinates in a display associated with the client computing devices.

7. A method of providing a coupled application extension to a remotely-accessed application, comprising:
providing a tiered remote access framework comprising an application tier, a server tier and a client tier, the tiered remote access framework enabling client computing devices to connect to the remotely-access application in a collaborative fashion, the tiered remote access framework further communicating a state model that contains first information utilized by the client computing devices to synchronize a display associated with the remotely-accessed application;
providing the coupled application extension in at least one of the server tier, the client tier and the application tier, the coupled application extension providing a functionality at the client computing devices by accessing the first information associated with the remotely-accessed application; and
modifying the state model to further include second information regarding the coupled application extension such that the functionality associated with the coupled application extension is enabled in at least one of the client computing devices.

8. The method of claim 7, further comprising providing the state model as a markup language document having a plurality of tags, wherein a first plurality of the tags are associated with the remotely-accessed application, and a second plurality of the tags are associated with the coupled application extension.

9. The method of claim 7, further comprising:
providing the coupled application extension at the application tier;
creating a second state model associated with the coupled application extension that includes the second information; and
communicating the second state model from application tier to either the server tier or the client tier.

10. The method of claim 9, wherein if the second state model is communicated to the server tier as part of the state model.

11. The method of claim 7, further comprising:
providing the coupled application extension at the client tier; and
providing the functionality in accordance with a display state of the remotely-accessed application at the client computing devices.

12. The method of claim 7, further comprising:
providing the coupled application extension at the server tier; and
providing the functionality by altering the first information in the state model.

13. The method of claim 7, further comprising:
providing the coupled application extension at the application tier as a separate executable from the remotely-accessed application; and
generating the second information from the first information to provide the functionality.

14. The method of claim 7, wherein the coupled application extension is a mapping tool, wherein the second information comprise a coordinates in a display associated with the client computing devices.

15. A tangible computer readable medium having computer readable instructions stored thereon that when executed by a processor of a computing device perform a method of providing a coupled application extension to a remotely-accessed application, the method comprising:
providing a tiered remote access framework comprising an application tier, a server tier and a client tier, the tiered remote access framework enabling client computing devices to connect to the remotely-access application in a collaborative fashion, the tiered remote access framework further communicating a state model that contains first information utilized by the client computing devices to synchronize a display associated with the remotely-accessed application;
providing the coupled application extension in at least one of the server tier, the client tier and the application tier, the coupled application extension providing a functionality at the client computing devices by accessing the first information associated with the remotely-accessed application; and
modifying the state model to further include second information regarding the coupled application extension such that the functionality associated with the coupled application extension is enabled in at least one of the client computing devices.

16. The tangible computer readable medium of claim 15, further comprising instructions for:
providing the coupled application extension at the application tier;
creating a second state model associated with the coupled application extension that includes the second information; and
communicating the second state model from application tier to either the server tier or the client tier.

17. The tangible computer readable medium of claim 16, wherein if the second state model is communicated to the server tier as part of the state model.

18. The tangible computer readable medium of claim 15, further comprising instructions for:
providing the coupled application extension at the client tier; and
providing the functionality in accordance with a display state of the remotely-accessed application at the client computing devices.

19. The tangible computer readable medium of claim 15, further comprising instructions for:
providing the coupled application extension at the server tier; and
providing the functionality by altering the first information in the state model.

20. The tangible computer readable medium of claim 15, further comprising instructions for:
providing the coupled application extension at the application tier as a separate executable from the remotely-accessed application; and
generating the second information from the first information to provide the functionality.
